(19) United States
(12) Patent Application Publication
(10) Pub. No.: US 2006/0114257 A1
(43) Pub. Date: Jun. 1, 2006

(54) Message display device and storage medium

(75) Inventor: Toshitsugu Nishimi, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: KYOCERA MITA CORPORATION

(21) Appl. No.: 11/287,196

(22) Filed: Nov. 28, 2005

(30) Foreign Application Priority Data
Nov. 30, 2004 (JP) 2004-347113

(51) Int. Cl. G06T 11/00

(52) U.S. Cl. 345/467

(57) ABSTRACT

A message display device includes: a display unit; a message data storage unit; a language selection unit; a readout unit; a character counting unit; a calculation unit calculating a display time for the character string data by multiplying the number of characters included in the character string data by one of coefficients corresponding to the designated language, the coefficients having been assigned to the group of languages; and a display control unit displaying the character string data using the display unit, and erasing the character string data having been displayed when the display time has elapsed.

### BACKGROUND OF THE INVENTION

1. Field of the Invention

This invention relates to a message display device and a storage medium, which control the time of display of messages to be displayed.

Priority is claimed on Japanese Patent Application No. 2004-347113, filed Nov. 30, 2004, the content of which is incorporated herein by reference.

2. Description of the Related Art

The photocopy machines, printers, multifunctional machines and similar of recent years have come to incorporate a variety of functions. A message which displayed on a screen during operation has become diverse as functions have been diversified. Such a diversification of functions has led to increasing complexity of the content of messages displayed when some operation not recognized by the equipment is performed. It is necessary to optimize the timing of display and the display time.

For example, Japanese Unexamined Patent Application, First Publication No. H05-324250, an image formation device is known in which, by computing the display time for one image and displaying the image with the number of characters of each character type in the image data sent from another device and the number of active bits of the graphic data as parameters, the display time can be made reasonable in keeping with the amount of information to be grasped.

Recent image formation devices can be used with the language of displayed messages switched for example from Japanese to English. However, in message display of the prior art, despite the fact that upon switching the language used a message with the same content may become long, the display time is fixed, so that there is the problem that the display time is short and all of the message cannot be read. On the other hand, there are cases in which, despite the fact that the displayed message is short, the display time is long, and so there is a problem in that operating performance is worsened.

### SUMMARY OF THE INVENTION

The present invention has been conceived in the light of the above described these circumstances, and an object of this invention is to provide a message display device and a storage medium capable of optimizing the display time of a message for display.

A message display device of this invention includes: a display unit adapted, for displaying a message, to display a character string constituted of a predetermined number of characters; a message data storage unit storing character string data for a message to be displayed expressed in a group of languages; a language selection unit selecting a designated language from the group of languages; a readout unit reading out the character string data expressed in the designated language, which has been selected by the language selection unit, from the message data storage unit when displaying of the message is required; a character counting unit determining the number of characters included in the character string data read out by the readout unit; a calculation unit calculating a display time for the character string data by multiplying the number of characters included in the character string data by one of coefficients corresponding to the designated language, the coefficients having been assigned to the group of languages; and a display control unit displaying the character string data using the display unit, and erasing the character string data having been displayed when the display time has elapsed.

A message display device of this invention includes: a display unit adapted, for displaying a message, to display a character string constituted of a predetermined number of characters, and to scroll the character string; a message data storage unit storing character string data for a message to be displayed expressed in a group of languages; a language selection unit selecting a designated language from the group of languages; a readout unit reading out the character string data expressed in the designated language, which has been selected by the language selection unit, from the message data storage unit when displaying of the message is required; a character counting unit determining the number of characters included in the character string data read out by the readout unit; a determining unit, when displaying the character string data read out by the readout unit, comparing a number of displayable characters using the display unit with the number of characters counted by the character counting unit, and determining whether scrolling the character string data using the display unit is necessary or not; a calculation unit, when scrolling the character string data using the display unit is necessary, calculating a display time for the character string data on each display line of the display unit, by obtaining the number of characters in each display line, and by multiplying the number of characters included in the character string data on the each display line by one of coefficients corresponding to the designated language, the coefficients having been assigned to the group of languages; and a display control unit displaying the character string data on the each display line using the display unit, erasing the character string data having been displayed, and scrolling the character string data when the display time has elapsed.

A storage medium of this invention, having a display control program stored therein for operating a message display device which has a display unit adapted, for displaying a message, to display a character string constituted of a predetermined number of characters, a message data storage unit which stores character string data for a message to be displayed expressed in a group of languages, and a computer which executes the display control program, includes: a language selection step of selecting a designated language from the group of languages; a readout step of reading out the character string data expressed in the designated language, which has been selected by the language selection step, from the message data storage unit when displaying of the message is required; a character counting step of determining the number of characters included in the character string data read out by the readout step; a calculation step of calculating a display time for the character string data by multiplying the number of characters included in the character string data by one of coefficients corresponding to the designated language, the coefficients having been assigned to the group of languages; and a display control step of displaying the character string data using the display unit, and erasing the character string data having been displayed when the display time has elapsed.

A storage medium of this invention, having a display control program stored therein for operating a message display device which has a display unit adapted, for displaying a message, to display a character string constituted of a predetermined number of characters, to scroll the character string, a message data storage unit which stores character string data for a message to be displayed expressed in a group of languages, and a computer which executes the display control program, includes: a language selection step of selecting a designated language from the group of languages; a readout step of reading out the character string data expressed in the designated language, which has been selected by the language selection step, from the message data storage unit when displaying of the message is required; a character counting step of determining the number of characters included in the character string data read out by the readout step; a determining step, when displaying the character string data read out by the readout step, comparing a number of displayable characters using the display unit with the number of characters counted by the character counting step, and determining whether scrolling the character string data using the display unit is necessary or not; a calculation step, when scrolling the character string data using the display unit is necessary, calculating a display time for the character string data on each display line of the display unit, by obtaining the number of characters in each display line, and by multiplying the number of characters included in the character string data on the each display line by one of coefficients corresponding to the designated language, the coefficients having been assigned to the group of languages; and a display control step of displaying the character string data on the each display line using the display unit, and erasing the character string data having been displayed, and scrolling the character string data when the display time has elapsed.

According to this invention, the display time is changed according to the number of characters, so that the content intended for the user can be conveyed easily, and after displaying the message for a helpful length of time, the message is erased, with the advantageous result that operability can be improved without continuation of a state of unnecessary message display.

### BRIEF DESCRIPTION OF THE DRAWINGS

FIG. 1 is a block diagram of showing a configuration of one embodiment of the invention.

FIG. 2 is a flowchart of showing an operation of the control portion shown in FIG. 1.

FIG. 3 is an explanatory drawing of showing a table structure of a message data storage portion shown in FIG. 1.

FIG. 4 is an explanatory drawing of showing scrolling display operation.

### DETAILED DESCRIPTION OF THE INVENTION

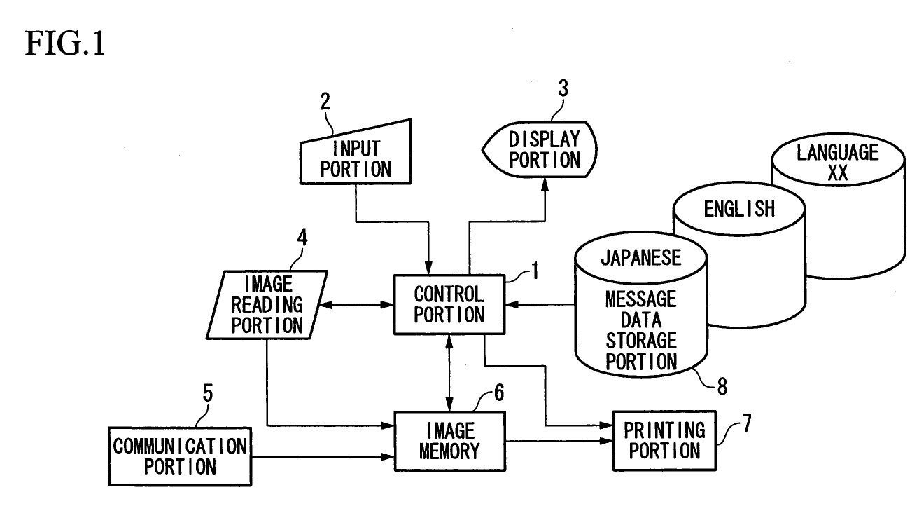

Below, the message display device of one embodiment of the invention is explained, referring to the drawings. FIG. 1 is a block diagram of showing the configuration of the embodiment. In this embodiment, an example is explained of a message display device installed in an image formation device. In FIG. 1, reference symbol 1 denotes the control portion which executes comprehensive control of the processing operation of the entire image formation device. Reference symbol 2 is an input portion, configured from a numeric keypad, function keys, a touch-screen, or similar. Reference symbol 3 is a display portion, configured from a liquid crystal display or similar, and having a message display area capable of displaying three lines of character strings, each with 20 double-byte characters. Reference symbol 4 is an image reading portion which reads the image of a manuscript or similar placed on a manuscript holder. Reference symbol 5 is a communication portion which receives printing data from a host computer, not shown.

Reference symbol 6 is image memory which stores printing data read out by the image reading portion and printing data received in the communication portion 5. Reference symbol 7 is a printing portion which performs printing to a form, based on the data stored in the image memory 6. Reference symbol 8 is a message data storage portion which stores, in each using language, character string data of a message to be displayed on the display portion 4. The explanation assumes that message data is stored in three using languages, Japanese, English, and Korean. The message data may be stored in four or more using languages.

In the image formation device, the using language is selected by the user, and an identifying name for the selected using language is stored within the image formation device.

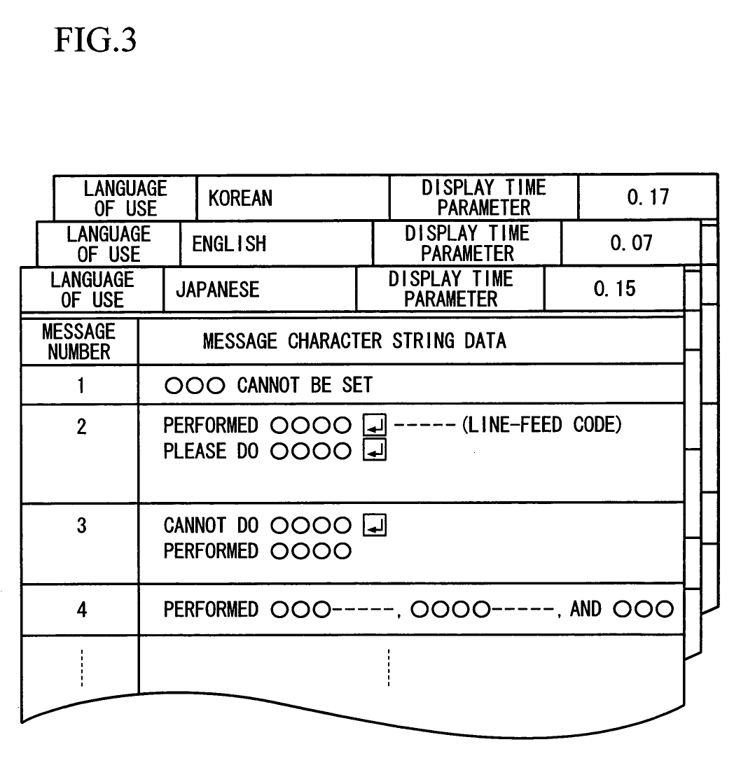

The table structure of the message data storage portion 8 shown in FIG. 1 is explained, referring to FIG. 3. As shown in FIG. 3, the table of the message data storage portion 8 stores an identifier name to identify the using language (in FIG. 3, “Japanese”, “English”, “Korean”), a display time parameter to change the display time for each using language, and message character string data for each message number. In FIG. 3, a table with message data referenced when the using language is Japanese is shown, but when the using language for the message character string data is English or also, the expression merely employs the using language, whereas the meaning of the message and the assigned message number are the same. The message character string data is of two types, which are the data containing line-feed codes within the character string (in the example shown in FIG. 3, the character strings with the message numbers “2” and “3”), and data not containing line-feed codes in the character string (in the example shown in FIG. 3, the character strings with the message numbers “1” and “4”).

The display time parameters are values determined and stored in advance for each of the using languages. When the same number of characters is displayed, larger value of the display time parameters cause a message to be displayed for a longer time. In the example shown in FIG. 3, there is the relation in which the display time parameter of Japanese is larger than the display time parameter of English. This is because, when character strings with the same number of characters of different types in different using languages are compared, the larger the number of character types per character, the larger the number of combinations which can be used to construct a character string, so that a user requires more time to read and understand the content of the character string. Hence the value of the display time parameter is larger when the number of types of one character is large, as in the case of Japanese (with hiragana and katakana syllabaries and kanji ideographs), and is small when there are few character types, as in English (which has only the alphabet).

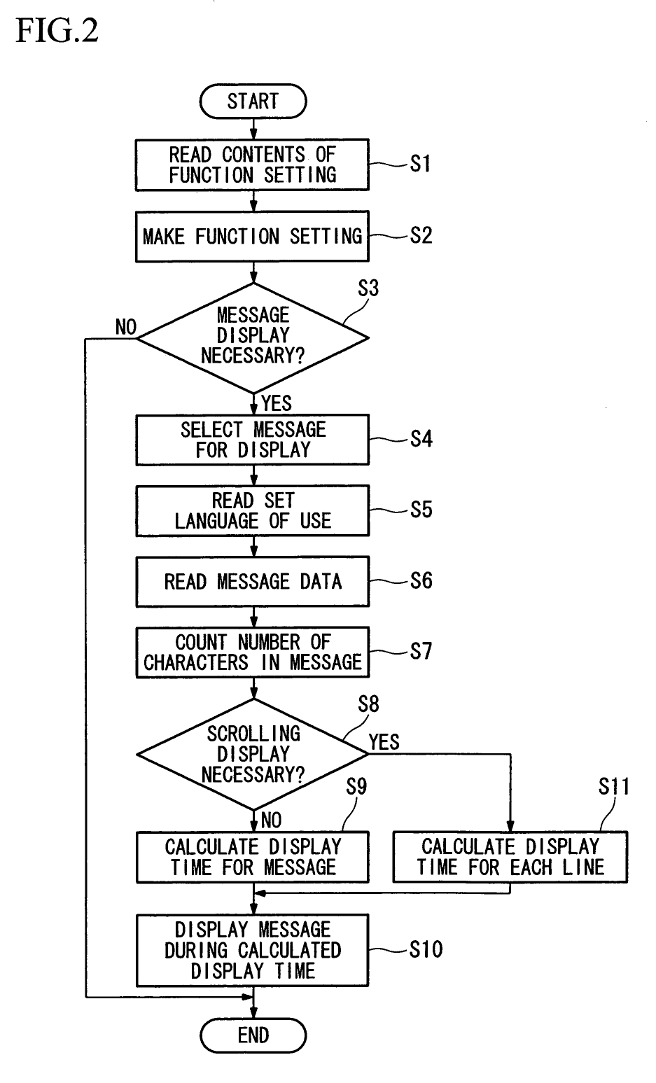

Next, operation of the control portion 1 shown in FIG. 1 is explained, referring to FIG. 2. First, the user performs a function setting operation to set the resolution during image reading of the image reading portion 4. In response, the control portion 1 reads the contents of the function setting set using the input portion 2 (step S1). The control portion 1 then performs the function setting for the image reading portion 4, based on the read-out function setting contents (step S2).

Next, the control portion 1 obtains from the image reading portion 4 a response to the function setting just performed, and based on this response, judges whether there is a need to display a message on the display portion 4 (step S3). If as the result of this judgment there is no need for display, processing ends. On the other hand, if in the function setting an attempt is made to set the resolution setting to the maximum value during binary reading, despite the fact that the setting is a color reading setting, or in similar cases, the image reading portion 4 returns to the control portion 1 a response indicating that the setting cannot be made. Upon receiving this, the control portion 1 judges that message display is necessary, and selects a message number for display when an attempted function resolution setting is not possible (step S4).

Next, the control portion 1 reads the identifier name of the using language stored internally (step S5). The control portion 1 then reads, from the message data storage portion 8, message character string data having the selected message number, and written in the using language of the read-out identifier name (step S6).

Next, the control portion 1 counts the number of characters in the message character string data read from the message data storage portion 8 (step S7). The control portion 1 then uses the number of characters obtained by counting and the number of line-feed codes contained in the character string, as well as the number of characters which can be displayed in the display area of the display portion 3, to judge whether scrolling display is necessary (step S8). That is, a judgment is made as to whether, when a character string containing line-feed codes is displayed in the display area of the display portion 3, the number of lines of the display area (in this example, three lines) is exceeded.

If as a result of this judgment scrolling display is not necessary, the control portion 1 calculates the display time for the message (step S9). The display time is calculated by multiplying the number of characters in the message character string to be displayed by a display time parameter, stored in the message data storage portion 8. For example, when a Japanese-language message character string contains 50 characters, multiplying 50 (the number of characters of the character string data) and 0.15 (the display time parameter of Japanese), equal 7.5 (s), so that the display time is 7.5 seconds. However, when the display time obtained by calculation is shorter than 1.5 seconds, the control portion 1 replaces the calculated display time with 1.5 seconds, which is the minimum display time.

Next, the control portion 1 displays the message on the display portion 3, based on the read-out message character string data. The control portion 1 then monitors the display time using an internal timer, and when the previously calculated display time has elapsed, erases the displayed message (step S10).

On the other hand, when scrolling display is necessary, the control portion 1 calculates the display time for each line of the display area (step S11). The display time is calculated by multiplying the number of characters in the message character string to be displayed on each line by the display time parameter stored in the message data storage portion 8. For example, if the message to be displayed has 10 characters on the first line, 15 characters on the second line, 8 characters on the third line, 13 characters on the fourth line, and 20 characters on the fifth line, then when the using language is Japanese, upon multiplying the number of characters on each line by the display time parameter, the display times are found to be 1.5 seconds for the first line, 2.25 seconds for the second line, 1.2 seconds for the third line, 1.95 seconds for the fourth line, and 3 seconds for the fifth line. the display times for each line, the control portion substitutes 1.5 seconds for the display time of the line with display time shorter than 1.5 seconds. In this example, the times are then 1.5 seconds for the first line, 2.25 seconds for the second line, 1.5 seconds for the third line, 1.95 seconds for the fourth line, and 3 seconds for the fifth line.

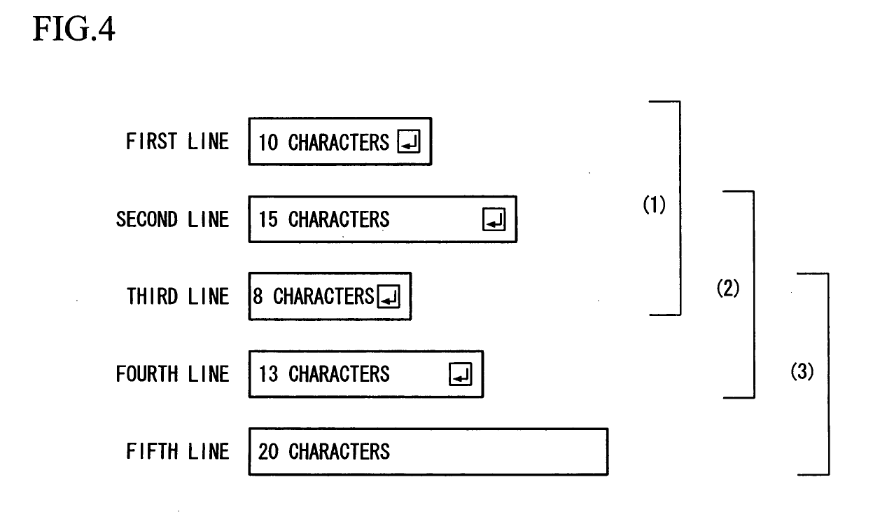

Next, the control portion 1 performs scrolling display on the display portion 3 of the message, based on the read-out message character string data (step S10). Scrolling display operation is explained referring to FIG. 4. First, the control portion 1 displays message character string data for the display area (three lines) on the display portion 3. By this means, the first through third lines are displayed on the display portion 3 ((1) in FIG. 4). Next, when the display time for the first line (1.5 seconds) has elapsed, the control portion 1 erases the first line, and displays the second through fourth lines ((2) in FIG. 4). When the display time (2.25 seconds) for the second line, which is displayed in the uppermost portion at this time, elapses, the second line is erased, and the third through fifth lines are displayed ((3) in FIG. 4). After scrolling is no longer necessary, when the sum total of the display times for each of the lines currently being displayed (1.5 seconds+1.95 seconds+3 seconds=6.45 seconds) elapses, all lines are erased.

Thus, the display time is changed according to the number of characters, so that the intended content can be easily conveyed to the user, and moreover data is erased after being displayed for an appropriate time, so that operability can be improved without continuation of a state of unnecessary message display.

The control portion 1 stores the message number of the message displayed immediately before, and when the message number of a message to be newly displayed is the same as the number of that displayed immediately before, the display time parameter may be made a value smaller than the value stored in the message data storage portion 8 (for example, in the case of Japanese, 0.1) to calculate the display time. By this means, the message display time when continuously displaying a message which the user has already seen can be shortened, so that operability can be improved. However, in this case also, when the display time is shorter than 1.5 seconds, the display time is replaced with the minimum display time of 1.5 seconds.

Moreover, a configuration may be adopted in which the user can freely set the value of the display time parameter and the minimum display time (1.5 seconds).

Further, a program to realize the functions of the processing portion in FIG. 1 may be recorded on computer-readable recording media, and a computer system may be caused to read and execute this program recorded on this recording media to perform display control processing. Here, a “computer system” includes an OS and peripheral equipment and other hardware. Moreover, a “computer system” includes a WWW system which includes an environment for web page presentation (or a display environment). Moreover, “computer-readable recording media” may be a flexible disk, magneto-optical disc, ROM, CD-ROM or other portable media, as well as a hard disk or other storage device incorporated into a computer system. In addition, “computer-readable recording media” also includes any means of holding the program for a length of time, such as volatile memory (RAM) within a computer system acting as a server or client when the program is transmitted via the Internet or other network or via telephone circuits or other communication circuits.

Further, the above program may be transmitted from a computer system which stores the program in a storage device or similar to another computer system, either via transmission media, or by means of transmission waves in transmission media. Here, “transmission media” to transmit the program is media having a function for transmission of information, such as the Internet or another network (communication network), or telephone circuits or other communication circuits (communication lines). Further, the above program may be intended to realize only a portion of the above-described functions. Also, the program of the above-described embodiment may be a so-called differential file (differential program) to realize the above-described functions through combination with a program already recorded in the computer system.

What is claimed is:

1. A message display device comprising:
a display unit adapted, for displaying a message, to display a character string constituted of a predetermined number of characters;
a message data storage unit storing character string data for a message to be displayed expressed in a group of languages;
a language selection unit selecting a designated language from the group of languages;
a readout unit reading out the character string data expressed in the designated language, which has been selected by the language selection unit, from the message data storage unit when displaying of the message is required;
a character counting unit determining the number of characters included in the character string data read out by the readout unit;
a calculation unit calculating a display time for the character string data by multiplying the number of characters included in the character string data by one of coefficients corresponding to the designated language, the coefficients having been assigned to the group of languages; and
a display control unit displaying the character string data using the display unit, and erasing the character string data having been displayed when the display time has elapsed.

2. A message display device comprising:
a display unit adapted, for displaying a message, to display a character string constituted of a predetermined number of characters, and to scroll the character string;
a message data storage unit storing character string data for a message to be displayed expressed in a group of languages;
a language selection unit selecting a designated language from the group of languages;
a readout unit reading out the character string data expressed in the designated language, which has been selected by the language selection unit, from the message data storage unit when displaying of the message is required;
a character counting unit determining the number of characters included in the character string data read out by the readout unit;
a determining unit, when displaying the character string data read out by the readout unit, comparing a number of displayable characters using the display unit with the number of characters counted by the character counting unit, and determining whether scrolling the character string data using the display unit is necessary or not;
a calculation unit, when scrolling the character string data using the display unit is necessary, calculating a display time for the character string data on each display line of the display unit, by obtaining the number of characters in each display line, and by multiplying the number of characters included in the character string data on the each display line by one of coefficients corresponding to the designated language, the coefficients having been assigned to the group of languages; and
a display control unit displaying the character string data on the each display line using the display unit, erasing the character string data having been displayed, and scrolling the character string data when the display time has elapsed.

3. A storage medium having a display control program stored therein for operating a message display device which has a display unit adapted, for displaying a message, to display a character string constituted of a predetermined number of characters, a message data storage unit which stores character string data for a message to be displayed expressed in a group of languages, and a computer which executes the display control program, comprising:
a language selection step of selecting a designated language from the group of languages;
a readout step of reading out the character string data expressed in the designated language, which has been selected by the language selection step, from the message data storage unit when displaying of the message is required;
a character counting step of determining the number of characters included in the character string data read out by the readout step;
a calculation step of calculating a display time for the character string data by multiplying the number of characters included in the character string data by one of coefficients corresponding to the designated language, the coefficients having been assigned to the group of languages; and
a display control step of displaying the character string data using the display unit, and erasing the character string data having been displayed when the display time has elapsed.

4. A storage medium having a display control program stored therein for operating a message display device which has a display unit adapted, for displaying a message, to display a character string constituted of a predetermined number of characters, to scroll the character string, a message data storage unit which stores character string data for a message to be displayed expressed in a group of languages, and a computer which executes the display control program, comprising:
a language selection step of selecting a designated language from the group of languages;
a readout step of reading out the character string data expressed in the designated language, which has been selected by the language selection step, from the message data storage unit when displaying of the message is required;
a character counting step of determining the number of characters included in the character string data read out by the readout step;
a determining step, when displaying the character string data read out by the readout step, comparing a number of displayable characters using the display unit with the number of characters counted by the character counting step, and determining whether scrolling the character string data using the display unit is necessary or not;
a calculation step, when scrolling the character string data using the display unit is necessary, calculating a display time for the character string data on each display line of the display unit, by obtaining the number of characters in each display line, and by multiplying the number of characters included in the character string data on the each display line by one of coefficients corresponding to the designated language, the coefficients having been assigned to the group of languages; and
a display control step of displaying the character string data on the each display line using the display unit, and erasing the character string data having been displayed, and scrolling the character string data when the display time has elapsed.
